(19) United States
(12) Patent Application Publication
(10) Pub. No.: US 2015/0194823 A1
(43) Pub. Date: Jul. 9, 2015

(54) BATTERY CHARGING DEVICE AND BATTERY CHARGING METHOD

(71) Applicant: SAMSUNG SDI CO., LTD., Yongin-si (KR)

(72) Inventors: Jae-Woo Kam, Yongin-si (KR); Hiroaki Takechi, Yongin-si (KR); Won-Chull Han, Yongin-si (KR)

(21) Appl. No.: 14/575,961

(22) Filed: Dec. 18, 2014

(30) Foreign Application Priority Data
Jan. 6, 2014 (KR) 10-2014-0001441

(51) Int. Cl. H02J 7/00

(52) U.S. Cl. CPC H02J 7/007; H02J 7/0068; H02J 2007/0098

(57) ABSTRACT

A battery charging device includes: a charging unit coupled to a battery module, the battery module including at least one battery cell, wherein the charging unit is configured to charge the battery module; and a charge controller configured to: receive, from a battery management system managing to battery module, measurement information indicating whether or not an open circuit voltage (OCV) value of the battery module is within a predetermined voltage section; and transmit a discharge start signal to the battery management system to discharge the battery module in response to a value of the measurement information exceeding a predetermined number.

### CROSS-REFERENCE TO RELATED APPLICATION

This application claims priority to and the benefit of Korean Patent Application No. 10-2014-0001441, filed in the Korean Intellectual Property Office on Jan. 6, 2014, the entire contents of which are incorporated herein by reference.

### BACKGROUND

1. Field

Aspects of embodiments of the present invention relate to a battery charging device and a battery charging method.

2. Description of the Related Art

Due to concerns about environmental disruption and resource exhaustion, interest in a system that can store power and that can efficiently use the stored power has increased.

A power storage system may store newly generated power in a battery or may store power of a commercial system in a battery by coupling the battery to the commercial system. The power storage system in turn supplies power that is stored in the battery to the commercial system or a load.

Rechargeable batteries capable of charging and discharging may also be used as part of a power storage system in order to store power. Rechargeable batteries differ from primary batteries in that rechargeable batteries can be repeatedly charged and discharged, while primary batteries typically are not designed to be recharged. Rechargeable batteries may be implemented as a single battery or as part of a battery module in which a plurality of batteries are combined as a single unit, depending on external devices to which it is applied.

There is a need, however, to more efficiently and effectively perform the charge and discharge operation, for example, by controlling the battery system.

The above information disclosed in this Background section is only for enhancement of understanding of the background and therefore it may contain information that does not constitute the prior art that is already known in this country to a person of ordinary skill in the art.

### SUMMARY

Aspects of embodiments of the present invention relate to a battery charging device that effectively charges a battery, and a battery charging method.

Aspects of embodiments of the present invention include a battery charging device in which a battery charge is prevented in a flat section when charging the battery, and a battery charging method.

Technical characteristics of the present invention are not limited to the above-described technical characteristics, and other technical aspects that are not described may be clearly understood by those skilled in the art from the following description.

According to some embodiments of the present invention, a battery charging device includes: a charging unit coupled to a battery module, the battery module including at least one battery cell, wherein the charging unit is configured to charge the battery module; and a charge controller configured to: receive, from a battery management system managing to battery module, measurement information indicating whether or not an open circuit voltage (OCV) value of the battery module is within a predetermined voltage section; and transmit a discharge start signal to the battery management system to discharge the battery module in response to a value of the measurement information exceeding a predetermined number.

The charge controller may be configured to receive open circuit voltage information of the battery module from the battery management system, and to transmit the discharge start signal to the battery management system in response to the open circuit voltage being within the predetermined voltage section.

The charge controller may be configured to transmit a charging start signal to the battery management system to charge the battery module in response to the open circuit voltage being outside the predetermined voltage section.

The charging unit may include a charging terminal coupled to the battery module and a coulomb counter configured to measure an open circuit voltage of the battery module using the charging terminal; and the charge controller may be configured to transmit the discharge start signal to the battery management system in response to the open circuit voltage value measured by the coulomb counter being within the predetermined voltage section.

The charge controller may be configured to transmit a charging start signal to the battery management system to charge the battery module in response to the value of the measurement information being less than the predetermined number.

The measurement information may include a count of the open circuit voltage being within the predetermined voltage section.

According to some embodiments of the present invention, a battery charging device includes: a charging unit coupled to a battery module, the battery module including a battery cell, wherein the charging unit is configured to charge the battery module; and a charge controller configured to measure an open circuit voltage value of the battery module and to control the charging unit to discharge the battery module when the open circuit voltage value is within a predetermined voltage section.

The charge controller may be configured to control the charging unit to charge the battery module in response to the open circuit voltage value being outside the predetermined voltage section.

According to some embodiments of the present invention, a battery charging method includes: receiving, from a battery management system managing a battery module, measurement information indicating whether or not an open circuit voltage value of the battery module is within a predetermined voltage section, wherein the battery module includes a battery cell; and transmitting a signal for discharging the battery module to the battery management system in response to a value of the measurement information exceeding a predetermined number.

The method may further include: receiving the open circuit voltage value from the battery management system; and generating the signal for discharging the battery module in response to the open circuit voltage value being within the predetermined voltage section.

The method may further include transmitting a signal for charging the battery module to the battery management system in response to the open circuit voltage being outside the predetermined voltage section.

The method may further include transmitting a signal for charging the battery module to the battery management system in response to the value of the measurement information being less than the predetermined number.

The measurement information may include a count of the open circuit voltage being within the predetermined voltage section.

According to some embodiments of the present invention, a battery charging method includes: measuring an open circuit voltage of a battery module including a battery cell; transmitting a signal for discharging the battery module to a battery management system managing the battery module in response to the open circuit voltage being within a predetermined voltage section; and transmitting a signal for charging the battery module to the battery management system in response to the open circuit voltage being outside the predetermined voltage section.

Characteristics of the battery charging device and the battery charging method according to the present invention are as described below.

According to at least one among example embodiments of the present invention, when charging the battery, the battery charge in the flat section may be prevented.

The above characteristics of the present invention are not limited to the aforementioned aspects, and other characteristics not described above will be apparent to those skilled in the art from the disclosure of the present invention.

### BRIEF DESCRIPTION OF THE DRAWINGS

FIG. 1 is a block diagram of a battery charging system according to embodiments of the present invention.

FIG. 2 is a flowchart of a battery charging method according to some embodiments of the present invention.

FIG. 3 is a graph of an OCV of a battery charged by a battery charging method according to embodiments of the present invention.

FIG. 4 is a flowchart of a battery charging method according to embodiments of the present invention.

FIG. 5 is a graph of an OCV of a battery charged by a battery charging method according to embodiments of the present invention.

### DETAILED DESCRIPTION

Aspects of embodiments of the present invention will be described more fully hereinafter with reference to the accompanying drawings, in which example embodiments are shown. As those skilled in the art would realize, the described embodiments may be modified in various different ways, all without departing from the spirit or scope of the present invention.

In addition, description of some features may be omitted for clarity, and like reference numerals designate like elements and similar constituent elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Now, a battery charging system and a battery charging method according to an example embodiment of the present invention will be described in some detail.

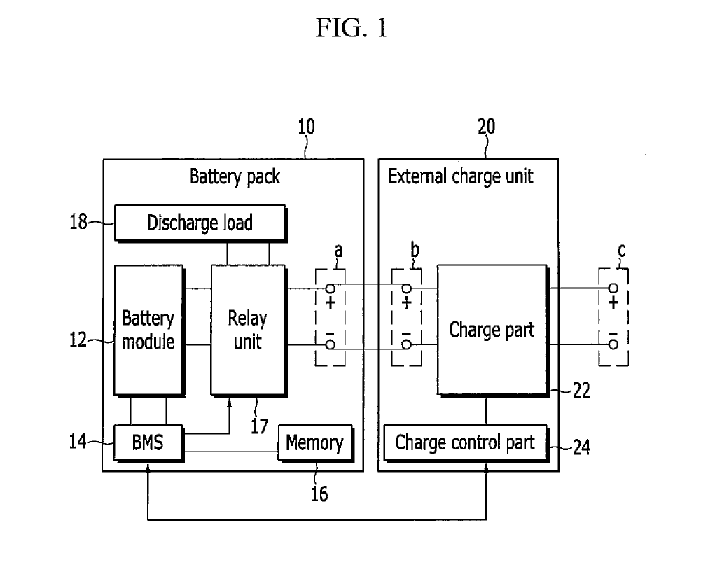

FIG. 1 is a block diagram of a battery charging system according to an example embodiment of the present invention. As shown, a battery pack 10 may be coupled to a charging unit 20.

The battery pack 10 includes a battery module 12, a battery management system (hereafter referred to as “BMS”) 14, a memory 16, a relay part 17, and a discharge load 18.

Firstly, the battery module 12 may include a plurality of battery cells coupled in series or in parallel and that are capable of being charged and discharged. Here, each cell has a rechargeable battery which is capable of being (or configured to be) charged and discharged may be one selected from the group including (or consisting of) a nickel-cadmium battery, a lead storage battery, a nickel-hydrogen battery, a lithium-ion battery, and a lithium polymer battery, or any other suitable rechargeable battery.

Also, the battery cell may be one selected from a group including (or consisting of) a cylindrical battery, a prismatic battery, a pouch battery, and equivalents thereof, however the shape of the battery cell is not limited thereto. The plurality of battery cells form one battery module 12, and may be used, for example, as a power source of an electric vehicle or a hybrid vehicle. Further, the battery pack 10 includes a pack terminal a, and the pack terminal a may be coupled to a charge part 22 of an external charge unit 20 to charge the battery module 12.

Also, the BMS 14 is coupled to, mounted to, or arranged within the battery pack 10 to efficiency manage the charge and discharge operation of the battery module 12. The BMS 14 manages the charge and discharge of the battery module 12, and may measure open circuit voltage (hereafter referred to as “OCV”), current, temperature, etc., of each battery cell. Here, the OCV is a measurement of the voltage in a no-load state such that the discharge load 18 is not operated when measuring the OCV of the battery cell.

The BMS 14 measures the OCV, the current, the temperature etc., of each battery cell, thereby estimating the OCV of the entire battery module, a state of charge (hereafter referred to as “SOC”) of each cell, and a state of health (hereafter referred to as “SOH”), and storing the OCV of the entire battery module, and the SOC and the SOH of each battery cell, which are estimated along with the OCV, the current, and the temperature of each battery cell to the memory 16 or transmitting them to the charging unit 20 connected by wire or wirelessly.

In this case, the BMS 14 may include a coulomb counter measuring the charge, the temperature, the open circuit voltage, a load cycle, or time of each battery cell.

Also, the BMS 14 may determine whether or not the OCV of the battery module 12 is changed within a flat section. For example, the BMS 14 may periodically measure the OCV of the battery module 12.

Also, the BMS 14 may accumulate a count of the number of times the OCV is measured within the flat section. The flat section may be a section or range of voltages in which a change amount of the OCV for the change of the SOC is no more than a threshold value (e.g., a predetermined threshold value) in a SOC-OCV relation curve. At this time, instead of the SOC, other factors such as a charging current, a discharge current, a charging elapsed time, a discharge elapsed time etc., may be used.

That is, while the power of the battery module 12 is used, when the OCV that is periodically measured is within the flat section, the BMS 14 may count the number of times that the OCV is measured within the flat section and store it in the memory 16.

Also, according to the control of the BMS 14, the relay part 17 may perform a switching operation of coupling the battery module 12 and the pack terminal a, or electrically coupling the battery module 12 and the discharge load 18.

Next, the discharge load 18 as a load consuming the power stored in the battery module 12 is coupled to the battery module 12 by the switching operation of the relay part 17, thereby discharging the battery module 12.

The charging unit 20 includes the charge part (or charger) 22 and a charge control part (or charge controller) 24. The charging unit 20 may charge the battery pack 10.

The charge part 22 charges the battery pack 10 and includes a charging terminal b. The charge part 22 charges the battery pack 10 if the charging terminal b is coupled to the pack terminal a of the battery pack 10. At this time, a positive terminal of the charge part 22 may be coupled to a positive terminal of the battery pack 10, and a negative terminal of the charge part 22 may be coupled to a negative terminal of the battery pack 10.

Thus, the charge part 22 supplies power supplied to an outer terminal c coupled to an external power source to the battery module 12 to charge the battery pack 10.

The charge control part 24 may charge or discharge the battery module 12 through the charging part 22 if the charging terminal b is coupled to the pack terminal a of the battery pack 10. Also, the charge control part 24 may receive information regarding the voltage, the current, and the temperature of each battery pack 10, the OCV, the SOH, and the SOC of the battery module 12, or the OCV change of the battery module 12 from the BMS 14 of the battery cell.

The BMS 14 and the charge control part 24 may include at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and any other suitable units to perform other functions.

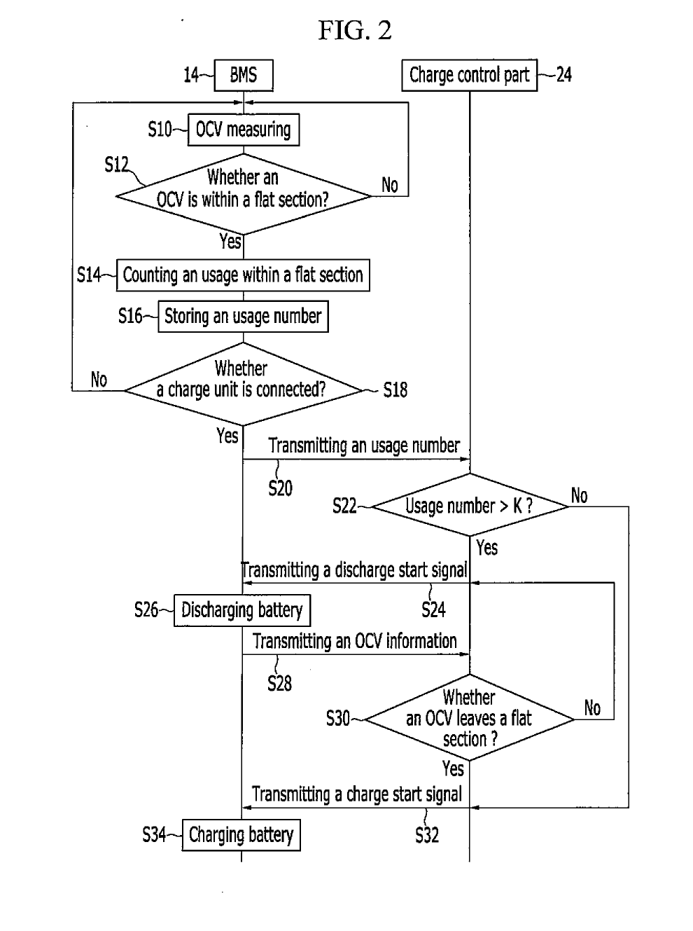

Next, a method of charging the battery module 12 according to the number of times that the OCV of the battery module 12 is changed will be described with reference to FIG. 2.

FIG. 2 is a flowchart of a battery charging method according to a first example embodiment of the present invention. The battery pack 10 is coupled to the load, thereby supplying the power stored to the battery pack 10 to the load. The load may be various electrical devices consuming the power such as home appliances or factory production equipment.

Firstly, the BMS 14 measures the OCV of the battery module 12 (S10). At this time, the BMS 14 periodically measures the OCV of the battery module 12, as described in FIG. 1.

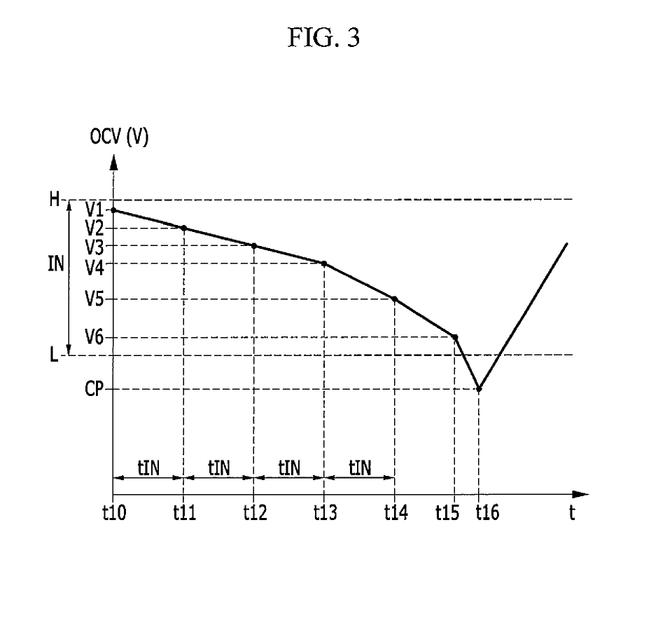

Thus, the BMS 14 determines whether the power is consumed by the load such that the decreased OCV of the battery module 12 is within a flat section IN (S12). Usage within the flat section IN will be described with reference to FIG. 3.

FIG. 3 is a graph of an OCV of a battery charged by a battery charging method according to a first example embodiment of the present invention. As shown in the drawing, the BMS 14 may measure the OCV of the battery module 12 with an interval of time (e.g., a predetermined amount of time) tIN.

The BMS 14 may initially measure the OCV of the battery module 12 at a time t10, and may measure the OCV of the battery module 12 at a time t11 after the predetermined amount of time tIN from the time t10. Also, BMS 14 may measure the OCV of the battery module 12 at a time t12 after the time t11 by the predetermined amount of time tIN, a time t13 after the time t12 by the predetermined amount of time tIN, and a time t14 after the time t13 by the predetermined amount of time tIN.

Firstly, at the time t10, the OCV of the battery module 12 may be measured as V1.

At the time t10, if the battery pack 10 is coupled to the load and the power stored to the battery module 12 is used, the OCV of the battery pack 10 may be decreased. That is, by the use of the power, the OCV of the battery module 12 of the time t11 is decreased to V2.

Because the OCV is decreased from V1 to V2, the BMS 14 may determine whether the power usage from the time t10 to the time t11 is within the flat section IN (between V=H and V=L).

Next, from the time t11 to the time t12, because the OCV of the battery module 12 is decreased from V2 to V3, the BMS 14 may determine whether the power usage from the time t11 to the time t12 is within the flat section IN.

From the time t12 to the time t13, because the OCV of the battery module 12 is decreased from V3 to V4, the BMS 14 may determine whether the power usage from the time t12 to the time t13 is within the flat section IN.

From the time t13 to the time t14, because the OCV of the battery module 12 is decreased from V4 to V5, the BMS 14 may determine whether the power usage from the time t13 to the time t14 is within the flat section IN.

Thus, because the OCV of the battery module 12 measured from the time t10 to the time t14 is within the flat section IN, the BMS 14 counts the usage number within the circuit flat section IN as a total of four times (S14) and stores the usage number to the memory 16 (S16).

Next, the BMS 14 determines whether or not the battery pack 10 is coupled to the external charge unit 20 (S18). For example, the coupling of the charge unit 20 may be determined through a sensor sensing whether the charging terminal b is coupled to the pack terminal a. Also, in a case that the battery pack 10 and the charge unit 20 are wirelessly coupled, the BMS 14 may determine the coupling of the charge unit 20 when receiving an initial connection start signal for a wireless power change.

Further, the BMS 14 transmits the usage number stored to the memory 16 to the charge unit 20 (S20). The BMS 14 and the charge unit 20 may be coupled through a separate terminal or a wireless communication network as well as the coupling between the pack terminal a and the charging terminal b.

On the other hand, the BMS 14 may also transmit the OCV information V6 of the battery module 12 at the time t15 to the charge control part 24. However, when the measuring of the OCV of the battery module 12 is possible through the charging terminal b of the charging unit 20, the transmission of the OCV information V6 of the battery module 12 may be omitted.

Thus, the charge control part 24 determines whether the usage number exceeds a number (e.g., a predetermined number) (S22). For example, the predetermined number may be set as 3 times.

When the usage number exceeds the predetermined number, the charge control part 24 transmits a signal for starting the discharge of the battery module 12 (S24). The charge control part 24 may transmit the signal for starting the discharge of the battery module 12 to the BMS 14 to discharge the battery module 12. Also, the charge control part 24 appropriately controls the charging part 22 to discharge the battery module 12.

At this time, the charge control part 24 may discharge the battery module 12 by further considering the OCV of the battery module 12.

For example, in a case that the charge control part 24 receives information for the current OCV of the battery module 12 from the BMS 14 or measures the current OCV of the battery module 12 through the charging terminal b, if the OCV of the battery module 12 is less than a lowest limitation value L of the flat section, the usage number is not determined, and a signal for starting the charge of the battery module 12 may be transmitted to BMS 14 S32.

Further, if the OCV of the battery module 12 exceeds the lowest limitation value L of the flat section, the charge control part 24 determines whether the usage number exceeds the predetermined number, and if the usage number exceeds the predetermined number, the charge control part 24 transmits the discharge start signal to the BMS 14, thereby discharging the battery module 12.

When the charge control part 24 transmits the signal starting the discharge of the battery module 12 to the BMS 14, the BMS 14 controls the switching operation of the relay part 17 to discharge the battery module 12 (S26) so as to couple the battery module 12 to the discharge load 18.

At the time t15 of FIG. 3, if the charging unit 20 and the battery pack 10 are coupled, the step S20 to the step S23 are performed, and the charge control part 24 may transmit the signal for discharging the power stored to the battery module 12 to the BMS 14.

Also, when the usage number is less than the predetermined number, the charge control part 24 may transmit the signal for starting the charge of the battery module 12 to the BMS 14 (S32).

After the discharge is started, the BMS 14 transmits the information for the OCV of the battery module 12 to the charge control part 24 (S28). If the measuring of the OCV of the battery module 12 is possible by the charging terminal b of the charging unit 20, the step S28 may be omitted.

Thus, the charge control part 24 determines whether the OCV of the battery module 12 leaves the flat section IN (S30). For example, because the power stored to the battery module 12 is discharged, the charge control part 24 may determine whether or not the OCV of the battery module 12 is less than a threshold value CP.

When it is determined that the OCV of the battery module 12 is less than the threshold value CP of the flat section IN, the charge control part 24 starts the charge of the battery module 12 (S30). At the time t16 of FIG. 3, the charge control part 24 may transmit the signal for starting the charge of the battery module 12 to the BMS 14 and supply the power to the battery module 12 through the charging part 22.

Thus, the BMS 14 controls the switching operation of the relay part 17 to charge the battery module 12 so as to couple the battery module 12 to the pack terminal a (S34).

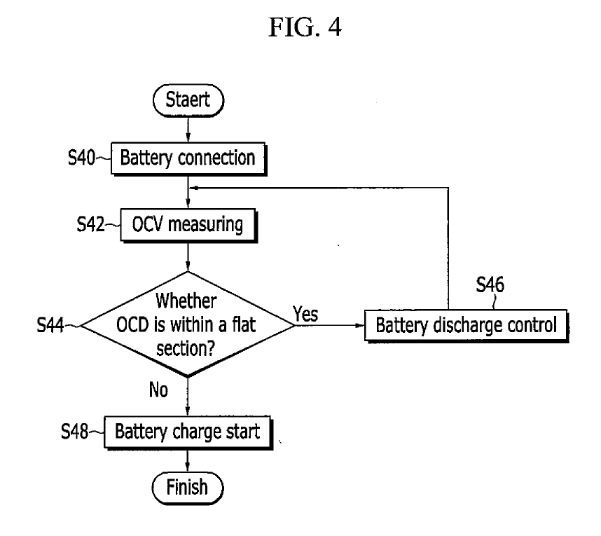

Next, the charge unit 20 measuring the OCV of the battery module 12 and charging the battery module 12 will be described with reference to FIG. 4.

FIG. 4 is a flowchart of a battery charging method according to an example embodiment of the present invention. As shown in the drawing, the charge unit 20 is coupled to the battery pack 10 (S40).

The charge control part 24 of the charge unit 20 measures the OCV of the battery module 12 (S42). For example, the charge control part 24 may measure the OCV of the battery module 12 by the charging terminal b. At this time, the charge control part may include the coulomb counter measuring the charge, the temperature, the open circuit voltage, and the load cycle or time of the battery module 12.

Thus, the charge control part 24 may determine whether or not the OCV of the battery module 12 is within the flat section IN. The OCV of the battery module 12 of the flat section IN with reference to FIG. 4 will now be described.

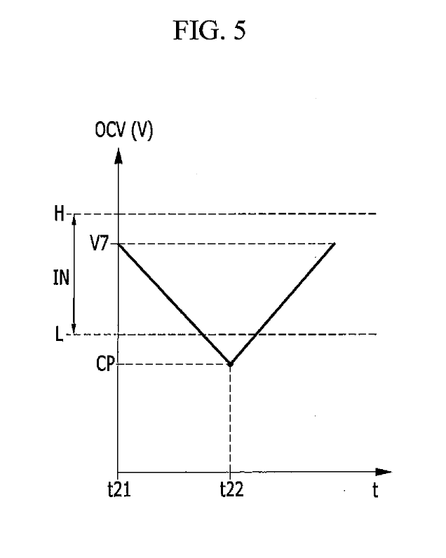

FIG. 5 is a graph of an OCV of a battery charged by a battery charging method according to a second example embodiment of the present invention. As shown in the drawing, the OCV of the battery module 12 at the time t21 is V7. The voltage value V7 may be determined as a value within the flat section IN (between V=H and V=L).

For example, the charge control part 24 may determine whether the OCV of the battery module 12 is within the flat section IN by using a plurality of comparators. The charge control part 24 may set the reference voltage of a first input terminal of a comparator as the highest limitation value H and the lowest limitation value L, and may apply the OCV of the battery module 12 to a second input terminal of the comparator. Thus, the charge control part 24 may determine whether or not the OCV of the battery module 12 is within the flat section IN by using the output of the comparator.

Next, when the OCV of the battery module 12 is within the flat section IN, the charge control part 24 transmits the signal for starting the discharge of the battery module 12 (S46).

Next, when it is determined that the OCV of the battery module 12 leaves the flat section IN according to the discharge, the charge control part 24 transmits the signal for starting the charge of the battery module 12 (S48).

For example, the charge control part 24 measures the OCV of the battery module 12 at the time t22, when the measured OCV is less than the threshold value CP, the signal charging the battery module 12 may be transmitted to the battery management system.

While aspects of the present invention have been described in connection with example embodiments, it is to be understood that the invention is not limited to the disclosed embodiments, but, on the contrary, is intended to cover various modifications and equivalent arrangements included within the spirit and scope of the appended claims and their equivalents. Therefore, those skilled in the art will understand that various modifications and other equivalent exemplary embodiments may be possible. In addition, a person of ordinary skill in the art may omit some of the components described in the present specification without deteriorating the performance, or may add components in order to improve the performance. Further, a person of ordinary skill in the art may change the sequence of the processes described in the present specification according to the process environments or equipment. Therefore, the scope of the present invention should be defined by the appended claims and their equivalents, not by the described example embodiments.

Description of Symbols

| | |
|---|---|
| 10: battery pack | 12: battery module |
| 14: BMS | 16: memory |
| 17: relay part | 18: discharge load |
| 20: charge unit | 22: charge part |
| 24: charge control part | |

What is claimed is:

1. A battery charging device comprising:
a charging unit coupled to a battery module, the battery module comprising at least one battery cell, wherein the charging unit is configured to charge the battery module; and
a charge controller configured to:
receive, from a battery management system managing to battery module, measurement information indicating whether or not an open circuit voltage (OCV) value of the battery module is within a predetermined voltage section; and
transmit a discharge start signal to the battery management system to discharge the battery module in response to a value of the measurement information exceeding a predetermined number.

2. The battery charging device of claim 1, wherein
the charge controller is further configured to receive open circuit voltage information of the battery module from the battery management system, and to transmit the discharge start signal to the battery management system in response to the open circuit voltage being within the predetermined voltage section.

3. The battery charging device of claim 2, wherein
the charge controller is configured to transmit a charging start signal to the battery management system to charge the battery module in response to the open circuit voltage being outside the predetermined voltage section.

4. The battery charging device of claim 1, wherein:
the charging unit comprises a charging terminal coupled to the battery module and a coulomb counter configured to measure an open circuit voltage of the battery module using the charging terminal; and
the charge controller is configured to transmit the discharge start signal to the battery management system in response to the open circuit voltage value measured by the coulomb counter being within the predetermined voltage section.

5. The battery charging device of claim 1, wherein
the charge controller is configured to transmit a charging start signal to the battery management system to charge the battery module in response to the value of the measurement information being less than the predetermined number.

6. The battery charging device of claim 1, wherein
the measurement information comprises a count of the open circuit voltage being within the predetermined voltage section.

7. A battery charging device comprising:
a charging unit coupled to a battery module, the battery module comprising a battery cell, wherein the charging unit is configured to charge the battery module; and
a charge controller configured to measure an open circuit voltage value of the battery module and to control the charging unit to discharge the battery module when the open circuit voltage value is within a predetermined voltage section.

8. The battery charging device of claim 7, wherein
the charge controller is configured to control the charging unit to charge the battery module in response to the open circuit voltage value being outside the predetermined voltage section.

9. A battery charging method comprising:
receiving, from a battery management system managing a battery module, measurement information indicating whether or not an open circuit voltage value of the battery module is within a predetermined voltage section, wherein the battery module comprises a battery cell; and
transmitting a signal for discharging the battery module to the battery management system in response to a value of the measurement information exceeding a predetermined number.

10. The battery charging method of claim 9, further comprising:
receiving the open circuit voltage value from the battery management system; and
generating the signal for discharging the battery module in response to the open circuit voltage value being within the predetermined voltage section.

11. The battery charging method of claim 10, further comprising
transmitting a signal for charging the battery module to the battery management system in response to the open circuit voltage being outside the predetermined voltage section.

12. The battery charging method of claim 9, further comprising
transmitting a signal for charging the battery module to the battery management system in response to the value of the measurement information being less than the predetermined number.

13. The battery charging method of claim 9, wherein
the measurement information comprises a count of the open circuit voltage being within the predetermined voltage section.

14. A battery charging method comprising:
measuring an open circuit voltage of a battery module comprising a battery cell;
transmitting a signal for discharging the battery module to a battery management system managing the battery module in response to the open circuit voltage being within a predetermined voltage section; and
transmitting a signal for charging the battery module to the battery management system in response to the open circuit voltage being outside the predetermined voltage section.
